(19) United States
(12) Patent Application Publication
(10) Pub. No.: US 2012/0106216 A1
(43) Pub. Date: May 3, 2012

(54) AC-DC CONVERTER WITH UNITY POWER FACTOR

(76) Inventors: Victor Tzinker, Jerusalem (IL); Sergey Khariton, Nazareth (IL)

(21) Appl. No.: 13/095,939

(22) Filed: Apr. 28, 2011

Related U.S. Application Data
(60) Provisional application No. 61/329,108, filed on Apr. 29, 2010.

(51) Int. Cl. H02M 7/06

(52) U.S. Cl. 363/126

(57) ABSTRACT

A method for construction of voltage or current power sources receiving an AC input, the power sources based on inclusion of a buffer stage feeding a converter operating with an output driver to a load. The buffer stage includes a buffer capacitance and a control means, such that the consumed input current from the AC input is proportional to the AC input voltage to the power source. The buffer capacitance functions as a charge buffer, enabling maintenance of the consumed input current over the entire period of the AC input voltage, and acting to separate the load from the consumed input current.

### FIELD OF INVENTION

The present invention relates generally to power supplies, and in particular to an AC-DC converter with unity power factor, including for the lighting industry and other illumination systems.

### BACKGROUND OF THE INVENTION

In the following description, reference will be made to electronic converters which are loaded by different types of electric loads. For example, these loads can be active or reactive; they can be loads with a threshold (cut-off) voltage, such as light emitting diodes (LED); resistive-capacitive or resistive-inductive loads; or any combination thereof. Most of these loads are nonlinear. In many cases they are powered by switched-mode power supplies (SMPS) connected to an AC power line. The electrical behavior of an SMPS depends on the properties of the load connected to it, and if this is a non-linear load, the behavior of the SMPS is affected accordingly.

A typical SMPS incorporates a simple full-wave rectifier connected to an input filter capacitance. The input rectifier conducts only when the power line instantaneous voltage exceeds the voltage on the filter capacitance. This leads to very high ratios of peak-to-average input current, which also leads to damage to the power factor. Usually, the power factor is corrected by means of a power factor corrector inserted between the input rectifier and the filter capacitor.

The power factor of an AC electric power system is defined as the ratio of the apparent power to the reactive power drawn from the AC line. The cause of a low value of the power factor is the non-proportionality of the consumed current waveform to the voltage waveform during part or all of the AC power line voltage cycle.

Prior art FIG. 1 is a schematic diagram of exemplary conventional AC-DC architecture of a switched mode power supply (SMPS) 100 used, for instance, in the lighting industry. An AC source 110 is connected to the input of an EMI filter 120, which filters out the high frequency components of the input current. The output of EMI filter 120 is coupled to the input of an input rectifier 130, which converts AC voltage of the power line into a DC voltage for a high frequency inverter 150. A bulk storage capacitor C 140 is placed at the output of rectifier 130, in order to smooth the rectified input voltage. The energy stored in bulk capacitor C 140 is used as the power source for inverter 150. The output of inverter 150 is connected to a power transformer T (160), which transforms the input voltage level suitable for the secondary side voltage level and provides galvanic insulation between primary and secondary sides. The output of power transformer 160 is connected to the input of a high frequency output rectifier 170, which rectifies the high frequency voltage provided by inverter 150 into a DC voltage. The combination of inverter 150, power transformer 160 and high frequency output rectifier 170 forms a converter 165. The output of output rectifier 170 is coupled to the input of a low pass filter 180, which smoothes the output current and voltage. The load 190 is connected to the output of low pass filter 180.

Prior art FIG. 2 is a graphical illustration of the waveforms of the SMPS of FIG. 1, i.e., the rectified input voltage V_{rect} 210, input current Iᵢₙ 230, and the output voltage V_{cap} 220 of the input rectifier, which is smoothed by the bulk capacitor C. It is clear that the current is consumed only when V_{rect} 210 is greater than V_{cap} 220.

Prior art FIG. 3 shows an alternative architecture 300 to FIG. 1, where the bulk capacitor 320 is placed at the output of the high frequency output rectifier 310. The wave-forms illustrated in FIG. 2 are also valid for this alternative architecture. In the architecture of FIG. 1 voltage waveform V_{cap} 220 is the same as for FIG. 3, except that the waveform is multiplied by the transformation factor of the converter.

From the point of view of power conversion, active loads do not require power factor correction since in a correct design the load current is a pulsed DC current proportional to the rectified AC power line voltage. However, additional requirements are often dictated by the application, such as a requirement to limit the output current ripple, or requirements regarding the waveform of the load current. In such cases simple power conversion is not possible.

Many nonlinear components such as LED's, diodes, etc. referred to below as cut-off loads, are characterized by a load threshold voltage (forward voltage) below which there is no load current flow. For such loads, the current flow occurs only during a portion of the AC voltage cycle, which affects the power factor. When the load threshold voltage is increased, the fraction of the AC cycle during which the current is present decreases, which reduces the power factor. In this case the power factor depends on the ratio between the RMS input AC line voltage and the load threshold voltage. The absence of the load current during a part of the AC half-cycle voltage, referred to below as “interrupted load current,” is a main disadvantage of the cut-off (threshold) types of loads.

Prior art FIG. 4 is a graphical illustration of the waveforms of the interrupted load current I_{load} 420, where there is a cut-off type of load, the load threshold voltage 410 and the rectified input voltage V_{rect} 430.

In the case where the load threshold voltage is comparable to the input AC line voltage, two basic problems arise:
1. The power factor can become unacceptably low; and
2. The wave form of the Interrupted load current can become unacceptable.

In order to maintain a high power factor with cutoff loads, the current consumption must be made proportional to the line voltage even when the load current is interrupted. In order to achieve this, the energy drawn from the AC power line during the absence of the load current should be transferred to the load, accumulated or dissipated.

In applications where the waveform of the load current is not critical and a pulsed current can be tolerated, the power factor can be improved by energy transfer to the load during the load cutoff periods, for instance, by means of the boost effect. As a result, the load current will be present during the cutoff periods and will vary proportionally to the rectified input voltage in each of the sub-periods. This, however, may not be acceptable in the applications where the load current must flow continuously and have a small ripple. In such cases one must resort to the other two strategies, with the input energy drawn during the cutoff periods dissipated or transferred to the load through an intermediate storage.

A simple way to provide a continuous flow of the load current is by using a storage capacitor calculated in such a way that its voltage is always maintained above the load threshold voltage. Prior art FIG. 5 is a graphical presentation of the waveforms 500 in such a case, where 520 is the voltage on the storage capacitor and 510 is the load threshold voltage. This, however, further reduces the power factor, as is clear from comparison of FIG. 5 with FIG. 4. The period of current consumption from the AC power line is reduced and peak input AC power line current 530 increases, which reduces the power factor.

To improve the power factor and neutralize other disadvantages caused by the use of storage capacitors, it is common to use power factor corrector (PFC) means.

Prior art FIG. 6 is schematic diagram of an exemplary AC-DC functional architecture 600 utilizing a PFC for improving the power factor of the system. This architecture is similar to the architecture of FIG. 1. The difference is the presence of a PFC 620 which is placed between the output of the input rectifier 610 and the bulk capacitor C 630.

Prior art FIG. 7 is a schematic circuit diagram illustrating a typical structure for the power factor corrector stage. There are several possible implementations of the PFC, with a common one shown in FIG. 7, which implements a boost effect, thereby ensuring consumption of the input current during both half-cycles of the AC power line voltage.

As a result, the consumed input current exactly matches the input voltage waveform and its phase. The boost converter 700 in FIG. 7 comprises an inductor L 710, switch S 720 (typically a MOSFET transistor), diode D 730 and a bulk capacitor C 740. The switch S 720 is controlled by a control system (not shown) which monitors the input and output signals of boost converter 700.

The control system of the PFC stage implements a control strategy based on feed-back loops, usually a voltage feedback loop and a current feedback loop. These feedback loops ensure that a current is constantly drawn by the PFC stage, based on a derived effective conductance of the PFC stage.

Luminaires for theatrical and architectural applications, for example, are provided with power by phase-cut dimmers, so that the lamps of the luminaires can be dimmed to operate at selected light levels.

The conventional PFC has several significant disadvantages:
1. it is difficult to achieve a satisfactory power factor for a wide range of loads;
2. in the case of rapid changes of the input voltage or the load current, over-voltage or under-voltage conditions may occur, caused by a slow response of the PFC feedback loops;
3. it is necessary to limit the in-rush current; and
4. the operation of the PFC becomes problematic in applications that comprise phase-cut dimmers.

Thus, it would be advantageous to provide a design that overcomes the above disadvantages.

### SUMMARY OF THE INVENTION

It is a principal object of the present invention to enable power conversion with a high power factor for a wide range of loads and also adheres to restrictions on the current waveform.

It is another principal object of the present invention to provide for power conversion which can be used for both low and high voltage applications (at primary or secondary sides of the conversion structures).

It is one other principal object of the present invention to provide for power conversion with loads that do not tolerate low-frequency current pulses, reactive loads and loads with a load voltage threshold.

A method is disclosed for construction of voltage or current power sources receiving an AC input, the power sources based on inclusion of a buffer stage feeding a converter operating with an output driver to a load. The buffer stage includes a buffer capacitance and a control means, such that the consumed input current from the AC input is proportional to the AC input voltage to the power source. The buffer capacitance functions as a charge buffer, enabling maintenance of the consumed input current over the entire period of the AC input voltage, and acting as a separator of the load from the consumed input current to the power source.

According to a first aspect of the invention, a dc/dc converter is placed between the rectifier and the smoothing filter capacitor, which together comprise the buffer stage. This results in a high power factor and avoids the need for correction or other control functions within the AC power line frequency period (with the exception of emergency functions).

According to a further aspect of the invention, continuous current consumption during the whole period of the AC power line is provided, which is important for proper stable operation of cut-phase dimmers of any leading edge or trailing edge type.

Summary of the advantages of the present invention:
1. High volume capacitance can be used only on the low voltage secondary side;
2. A single location for the high volume capacitance can be designed into the conversion structure;
3. No need to resort to feedback based correction procedures during the input AC voltage line period;
4. A high power factor is provided for a wide variety of loads;
5. Suitable for operation with cut-phase dimmers;
6. Significantly lower buffer capacitance than that the one required in conventional structures without power factor correction;
7. Possibility of using simple, capacitor-less converters in the primary side of the converter;
8. Possibility of using low voltage components in the buffer stage;
9. Simplifies the design of EMI filters;
10. It is possible to design low voltage, high power factor power conversion structures;
11. It is possible to design modular power conversion structures;
12. It is possible to accommodate different kinds of loads; and
13. It is possible to design a dimmable voltage source.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

Prior art FIG. 1 is a schematic diagram of exemplary conventional AC-DC architecture of a switched mode power supply (SMPS) used, for instance, in the lighting industry;

Prior art FIG. 2 is a graphical illustration of the waveforms of the SMPS of FIG. 1;

Prior art FIG. 3 illustrates an alternative architecture to that shown in PA FIG. 1, wherein the bulk capacitor is placed at the output of the high frequency output rectifier;

Prior art FIG. 4 is a graphical presentation of the waveforms for the case when the load has a cut-off (threshold) voltage V_{load};

Prior art FIG. 5 is a graphical presentation of the waveforms for the case of a capacitor voltage which is above the load cut-off voltage;

Prior art FIG. 6 is a schematic block diagram for an improved AC-DC functional architecture utilizing a PFC means for providing the power factor of the system;

Prior art FIG. 7 is a schematic circuit diagram illustrating a typical structure for power factor corrector stage;

FIG. 8 is a functional block diagram of a conversion structure with a high power factor, constructed in accordance with the principles of the present invention;

FIG. 9 is an equivalent schematic for the buffer stage with its load, constructed in accordance with the principles of the present invention;

FIG. 10 is a graphical presentation of waveforms for input current and input voltage of the low voltage high power factor system, constructed in accordance with the principles of the present invention;

FIG. 11b shows the functional structure of the power system which provides high power factor and high efficiency constructed in accordance with the principles of the present invention;

Prior art FIG. 11a shows a conventional converter, whereas FIG. 11b shows the converter of the present invention;

FIG. 12 is a schematic illustration of one of several alternative buffer stage implementations, constructed in accordance with the principles of the present invention;

FIG. 13 illustrates the functional structure of the buffer stage, constructed according to the principles of the present invention;

FIG. 14 is a graphical presentation of the waveforms of input current and input voltage of the low voltage high power factor system for the buffer stage of FIG. 13, constructed according to the principles of the present invention;

FIG. 15 is a schematic illustration of one of several possible buffer stage implementations, constructed in accordance with the principles of the present invention;

FIG. 16 shows one of the possible implementations of low voltage, high power factor power conversion structures, constructed according to the principles of the present invention;

FIG. 17 is an exemplary schematic application diagram for a Dimmable Voltage Source Converter, constructed in accordance with the principles of the present invention;

FIG. 18 is a functional structure diagram for a high efficiency, high power factor dimmable electronic transformer power system, constructed in accordance with the principles of the present invention; and

FIG. 19 is a functional structure diagram for system which provides improved conducted emission, constructed in accordance with the principles of the present invention.

### DETAILED DESCRIPTION OF EXEMPLARY EMBODIMENTS

The concept of the present invention is particularly suitable to low voltage applications, although it is not limited to them. Therefore, the concept shall be explained for low-voltage embodiments.

Prior art FIGS. 1-7 were already discussed in the background.

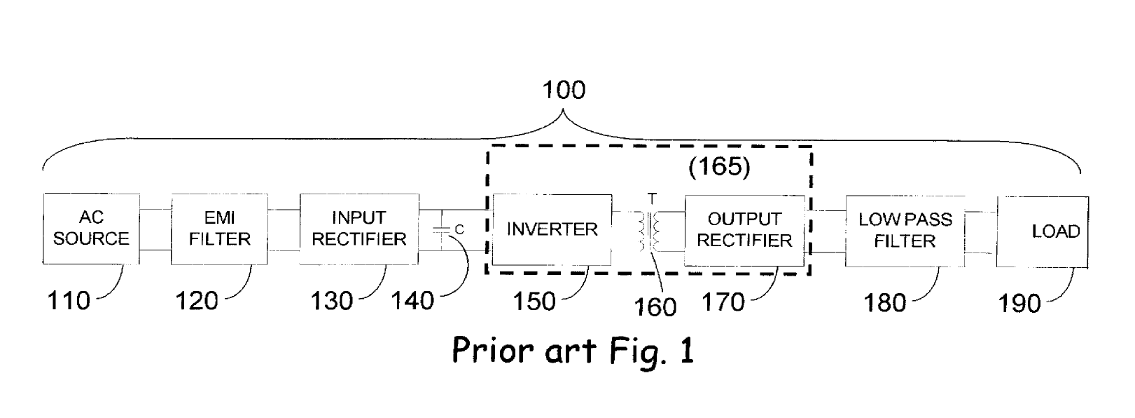

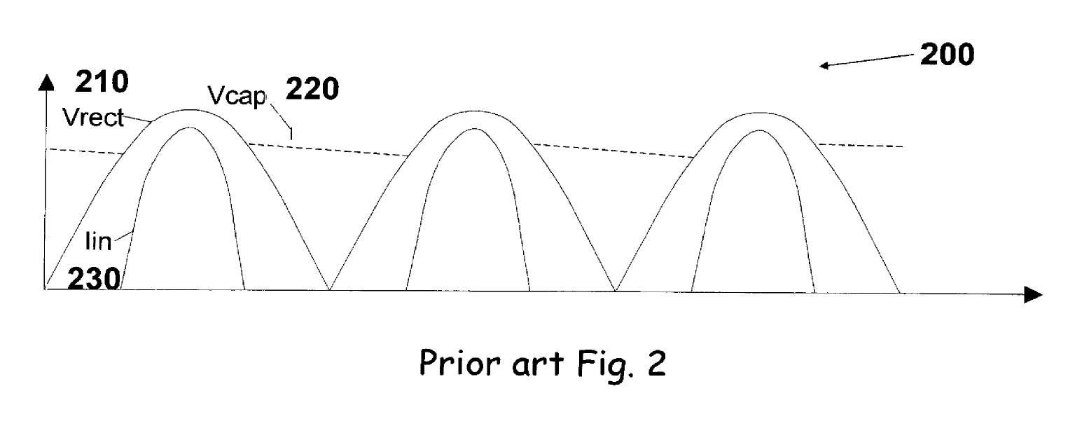

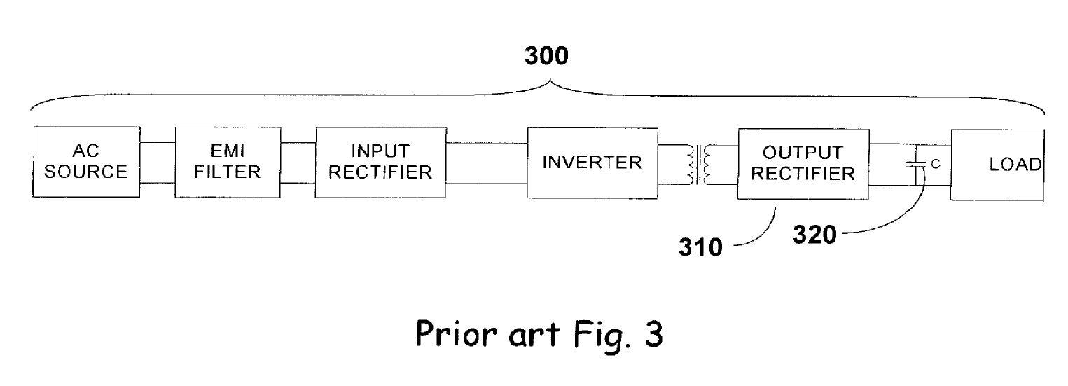

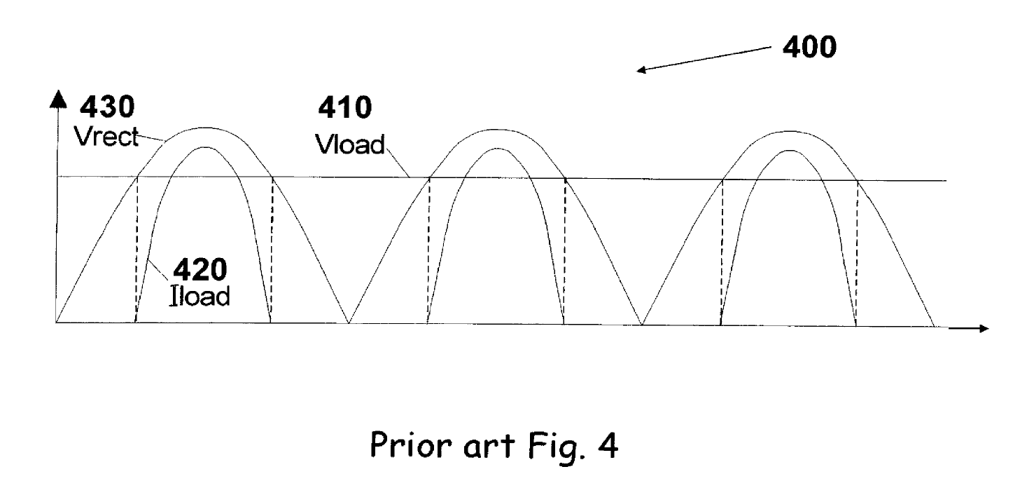

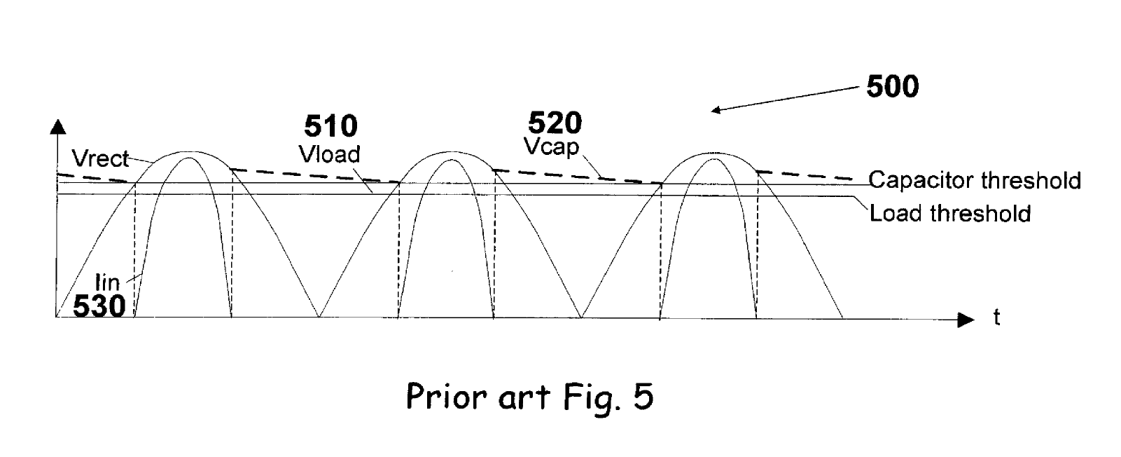

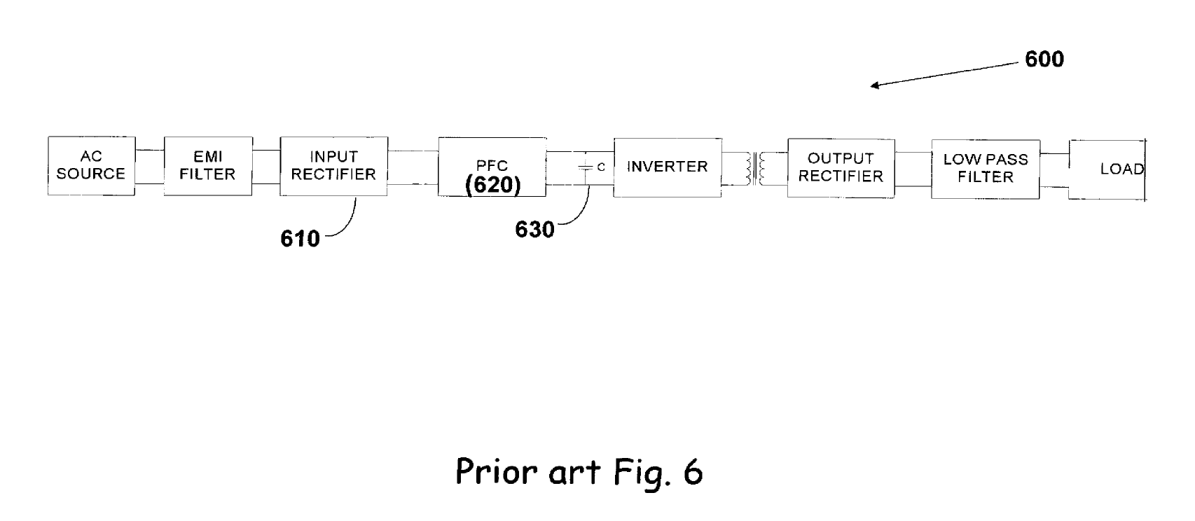

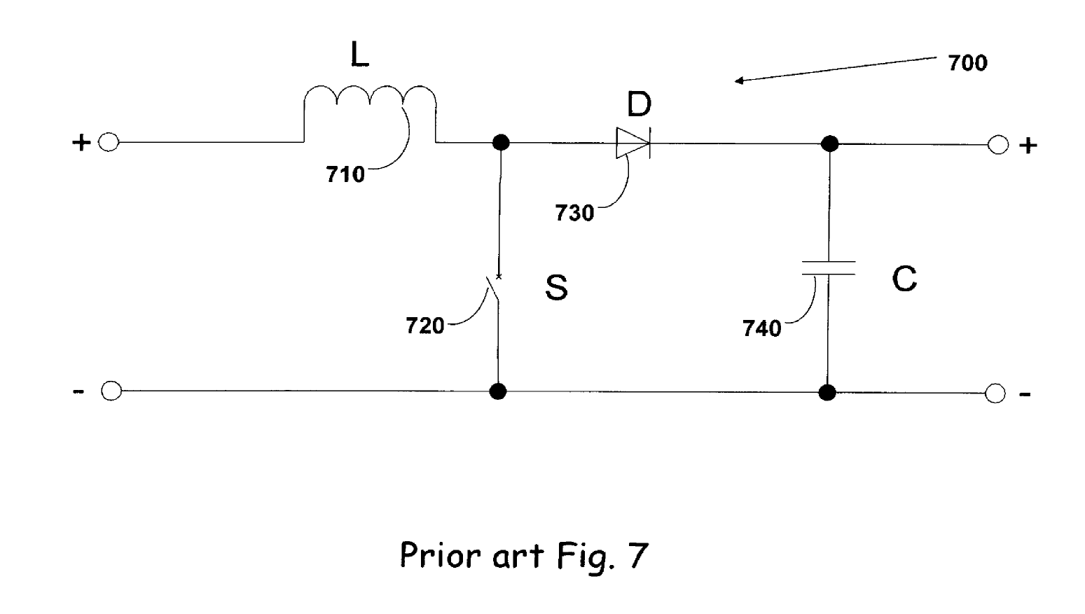

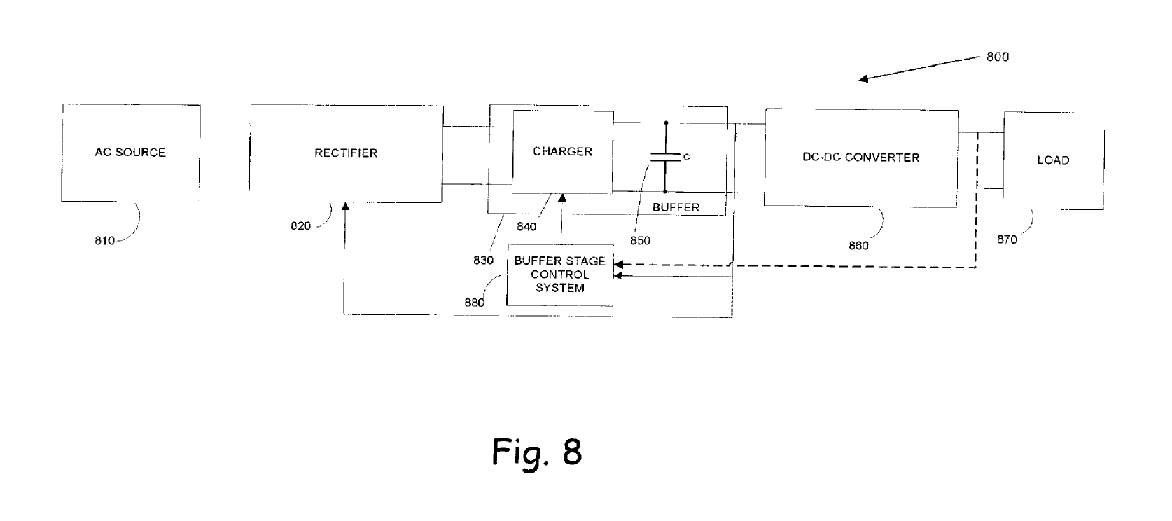

FIG. 8 illustrates the functional diagram of the conversion structure 800 with a high power factor, constructed in accordance with the principles of the present invention. The structure includes an AC power source 810 connected to the input of a rectifier 820. Rectifier 820 has no capacitors at its output and feeds a buffer stage 830. The function of buffer stage 830 is to make the consumed current proportional to the rectified AC power line voltage (which results in a high power factor) and to keep the buffer capacitor 850, that works as a charge buffer, charged to a voltage level sufficient to maintain its load current during the full period of the AC power line.

Buffer stage 830 comprises: buffer capacitor 850 (which also functions as a smoothing filter capacitor) connected across the output of buffer stage 830; a charger 840, which charges buffer capacitor 850; and a buffer stage control system 880, which controls the current of charger 840 using feedback loops as explained in detail below. The output of buffer stage 830 is coupled to the input of a DC-DC converter 860, which allows one to vary the output voltage over a wide range. Alternatively, buffer stage 830 can be connected directly to the load 870, which may be useful in high power factor applications having no special requirements for the output voltage, such as in heating applications or simple light sources.

Buffer stage control system 880 ensures the following in relation to the input power line:
a. consumed input current is proportional to the input voltage;
b. there is no reaction to changes of the input voltage that are rapid or comparable to AC power line cycle;
c. current is consumed at all times including the zero voltage point of the AC line cycle;
d. there is no interruption of input current consumption even in emergency conditions, which is essential for normal operation in embodiments with cut-phase dimmers; and
e. the system guarantees the presence of a minimal “zero” current under all conditions, which is very important for dimmer operation. Such current does not adversely affect the power factor, but results in lower impedance, which is important for operation with cut-phase dimmers.

The above conditions are important both for achieving a high power factor and for proper operation in systems with dimmers.

DC-DC converter 860 can be implemented as a constant voltage, constant current or constant power converter. In order to provide feedback to the buffer stage control system, one can measure the load parameters or buffer capacitor voltage. The operation of buffer stage 880 is further explained as follows in connection with FIG. 9.

FIG. 9 shows an equivalent schematic 900 for the system buffer stage with its load, constructed according to the principles of the present invention. The equivalent current source 910 represents the charger 840 of FIG. 8. The buffer stage control system 940 is equivalent to buffer stage 880 of FIG. 8, buffer capacitor 920 is the same as buffer capacitor 850 of FIG. 8, and 960 is the load of buffer stage 880 shown here as containing the DC-DC converter 950 and its load 930.

The schematic 900 of FIG. 9 works in the following way. At the initial moment, when current source 910 is switched on, buffer capacitor 850 is charged until a steady-state operation is reached. After that, its voltage V_{cap} is maintained by the control system 940 within the allowed limits. Changes in the load 930 or in the input voltage are compensated by control system 940.

The compensation by control system 940 is preferably very slow compared with the period of the AC power line input in order to preserve the proportionality of the input current to the input voltage, which ensures a high power factor.

The principle of operation can be further explained as follows. Let Δt be a characteristic correction time. The current imbalance ΔI between the source current I_{charge} and the load current I_{load} occurring during the time Δt will charge or discharge the buffer capacitor by a current I_{cap}=ΔI with a charge I_{cap}·Δt, raising its voltage by ΔV such that

CΔV=I_{cap}Δt

The capacitance of the buffer capacitor necessary to accommodate such changes can be calculated as

$$C = \frac{Δ I \cdot Δ t}{Δ V} \qquad Equation 1$$

where now ΔV is the maximum allowed voltage change on buffer capacitor 920 corresponding to the chosen operation voltage level, which is limited by the required minimal voltage and the maximum allowed voltage of load 930 (and of capacitor 920). Clearly, the larger the value of ΔV allowed, the smaller capacitance 920 can be. The characteristic time Δt must be chosen as large compared to the AC period in order to achieve a high power factor. On the other hand, an excessively large value of Δt will lead to very large values of required capacitance C 920 or its voltage level. In an exemplary embodiment, it is chosen to be 5-10 times larger than the line period.

It is important to emphasize that during the characteristic time Δt, the system is able to operate properly even in the presence of small changes of either input or load, whether rapid or gradual.

The choice of the voltage on buffer capacitor 920 and of its capacitance from the power factor point of view has been discussed above. Now additional considerations for choosing these values are presented.

From the load operation point of view, the voltage on buffer capacitor 920 should be greater than the minimum voltage of the load, V_{load min} and lower than the maximum voltage of the load V_{load max}. If the load of buffer stage 900 consists of DC-DC converter 950 with its load 930 (FIG. 9), then the following conditions are preferable:
(1) the voltage on buffer capacitor 920 should be greater than V_{load min} by some ΔV_{load min} that will ensure normal load operation even at a minimal voltage of buffer stage 900, and
(2) the voltage on buffer capacitor 920 should be lower than V_{dc-dc max}, ensuring a normal load operation and avoiding emergency conditions for DC-DC converter 950.

Therefore, the calculations preferably accommodate the limits imposed on the buffer capacitance and its voltage. In addition, one must take into account the fact that the capacitance of electrolytic capacitors tends to decrease with time (the “drying-out” effect). Therefore, if electrolytic capacitors are to be used, it is necessary to provide an excess charge storage capacity by further increasing the capacitance. Namely, the ΔV to be used in the calculation must reflect the smaller capacitance corresponding to the end of its useful life time, rather than the nominal value.

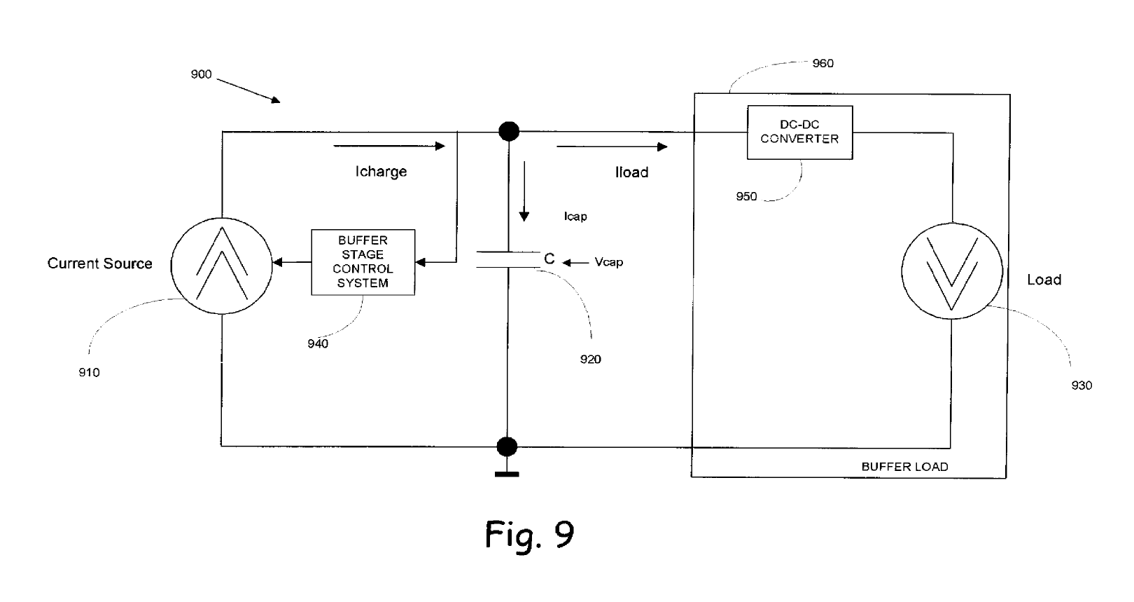

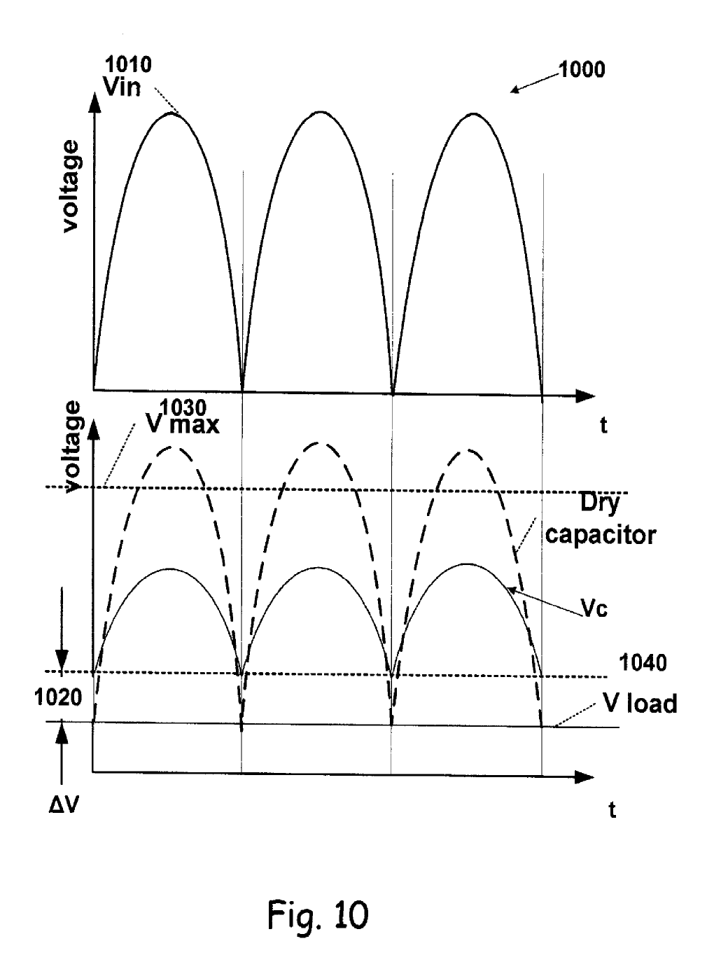

FIG. 10 is a graphical presentation of waveforms for input voltage 1010 of the low voltage high power factor system, constructed in accordance with the principles of the present invention. The change of the operation of the buffer stage in the case of drying out of the buffer capacitor is illustrated in FIG. 10.

FIG. 10 shows the waveforms of the input voltage Vᵢₙ 1010 and the voltage V_{C} on the buffer capacitor. Also shown are the load voltage V_{load} 1040, the maximum input voltage Vₘₐₓ 1030 of the subsequent stage, and the voltage difference ΔV 1020 between the minimum of the actual voltage on the buffer capacitor and the actual voltage on the load. With time, the buffer capacitor capacitance decreases and the voltage ripple on the buffer capacitor increases (dashed line on FIG. 10).

Summarizing the above discussion, the buffer stage stores energy in the capacitance in order to:
1. continuously consume input current without rapid reaction to input voltage changes, ensuring a high power factor; and
2. maintain the buffer voltage within the allowed limits under changes of the input AC voltages or of the load.

The advantage of the present approach can be shown by comparison with a conventional DC-DC converter that does not employ a power factor corrector.

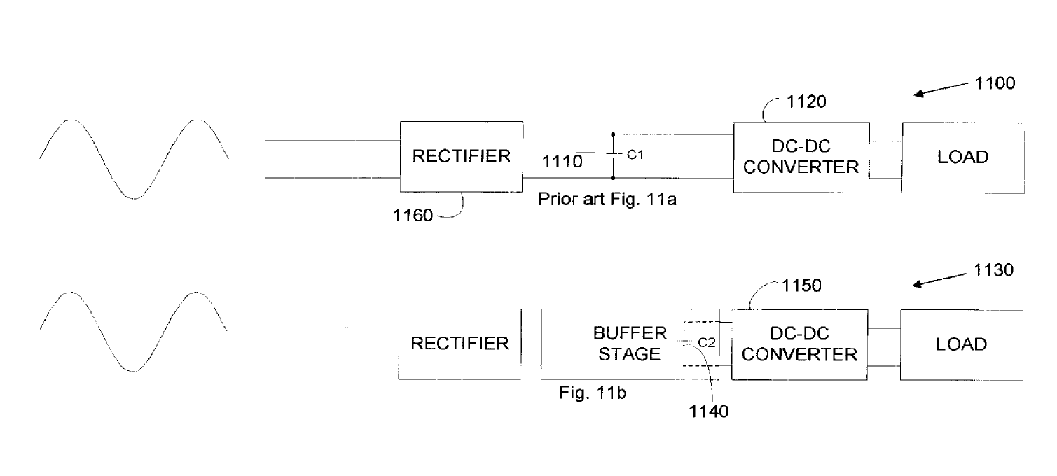

Prior art FIG. 11a shows such a conventional converter 1100, whereas FIG. 11b shows the converter of the present invention 1130. The boost effect employed in the buffer stage of the converter of FIG. 11b allows one to use a smaller capacitance 1140 at the input of the DC-DC converter 1150, compared to the very large capacitor 1110 at the input of the DC-DC converter 1120 needed to suppress the voltage ripple in the conventional converter prior art FIG. 11a.

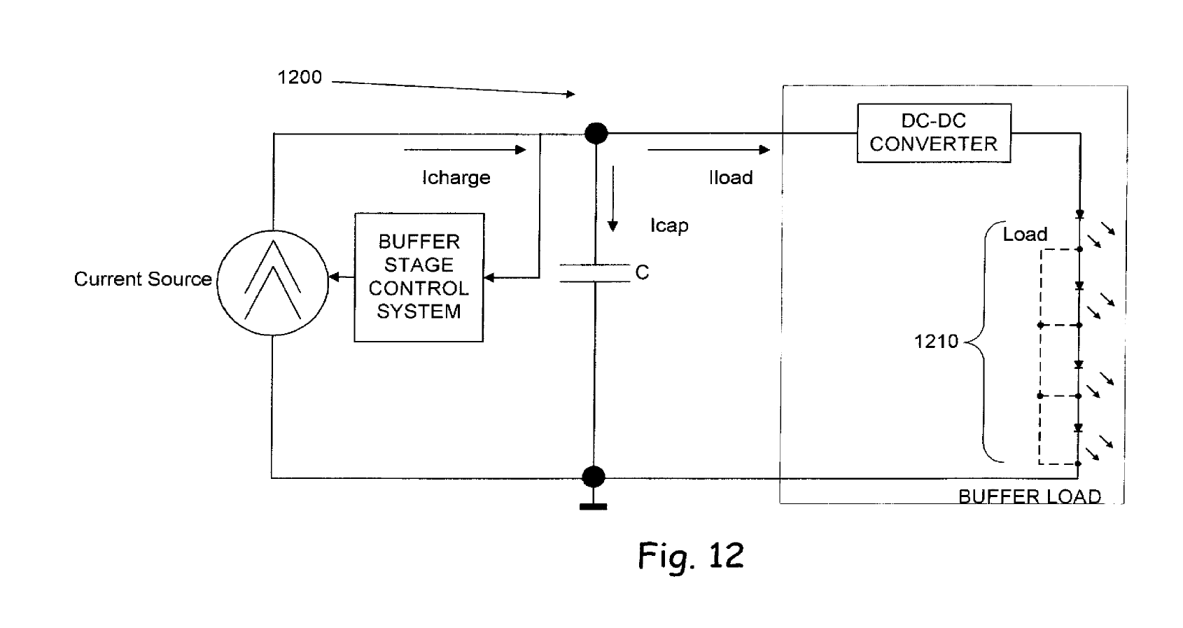

FIG. 12 is a schematic illustration of one of several alternative buffer stage implementations 1200, constructed in accordance with the principles of the present invention. The following applies to the case where the load can change considerably, which may occur, for example, when changing the number of serially connected light emitting diodes (LED's) 1210, as illustrated in FIG. 12, which is a modification of FIG. 9 for variable loads.

In this case the solution is to monitor the load or the buffer voltage and use the control system to change charging the buffer capacitor accordingly to load conditions. The implementation is discussed in connection with FIG. 8 above.

In order to accommodate the full dynamic range of varying loads, one can close the voltage feedback loop to buffer stage control system 880 either from load 870 or from the buffer output. Both options allow one to compensate for the changes of load 870. If the number of LED's in the load is reduced, then the power drawn by the LED's will decrease and the current drawn by the DC-DC converter will also decrease. As a result, the current imbalance ΔI will grow and the voltage on the buffer capacitor will also grow. This imbalance is compensated either using a local feedback loop of buffer stage control system 880 or using the system feedback loop (dashed line) that changes the input voltage to the buffer stage (by modifying the operation of rectifier 820).

In the same way, these feedback loops can accommodate the imbalance caused by changes in the input.

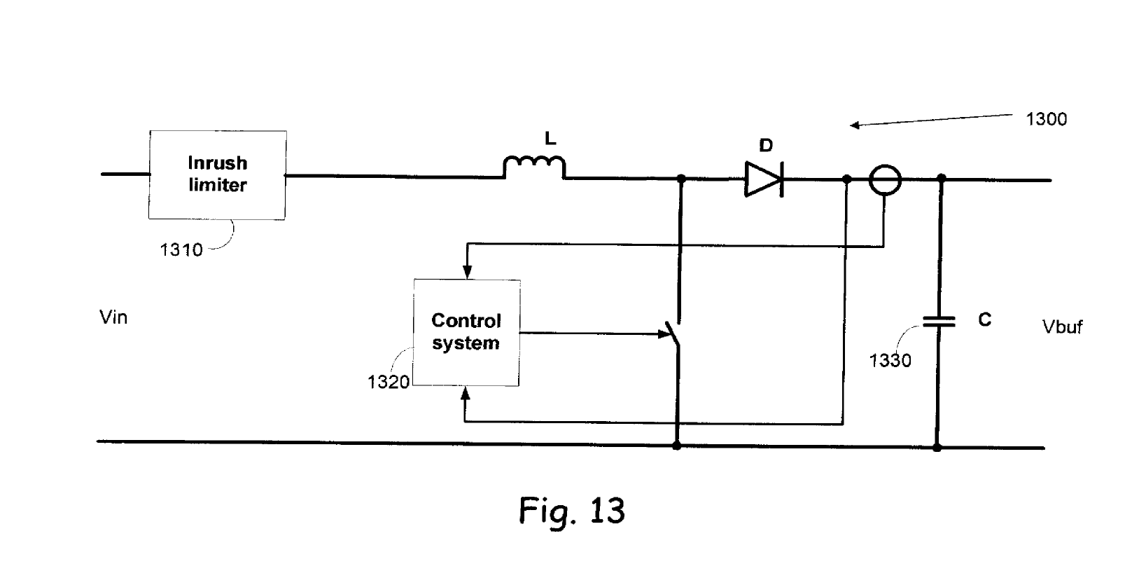

FIG. 13 illustrates the functional structure of the buffer stage, constructed according to the principles of the present invention. In general, the buffer stage DC-DC converter can be implemented as boost, buck-boost or any other topology that can provide the required functions. One of several possible implementations of the buffer stage is shown in FIG. 13.

In order to simplify the explanation, the boost topology has been chosen in FIG. 13. An in-rush limiting component 1310 should be provided in the capacitor charging circuit in order to limit the current during the start of the buffer stage operation. In the example of FIG. 13 such an element is placed at the input of the buffer stage, but it can also be placed at a preceding stage. The level and the rate and character of the change of the voltage change on the buffer capacitor are controlled in order to maintain normal load operation as described above.

As described above, corrections must be slow compared with the period of the AC power line in order to stay in the defined range of voltage on buffer capacitor 1330 and in order not to affect the proportionality between the input voltage and current. For example, as shown in FIG. 13, one can limit the voltage variation to the required range by means of voltage feedback loop in the following way: the control system 1320 controls the voltage on the buffer capacitor 1330 and corrects the duty cycle of the boost converter.

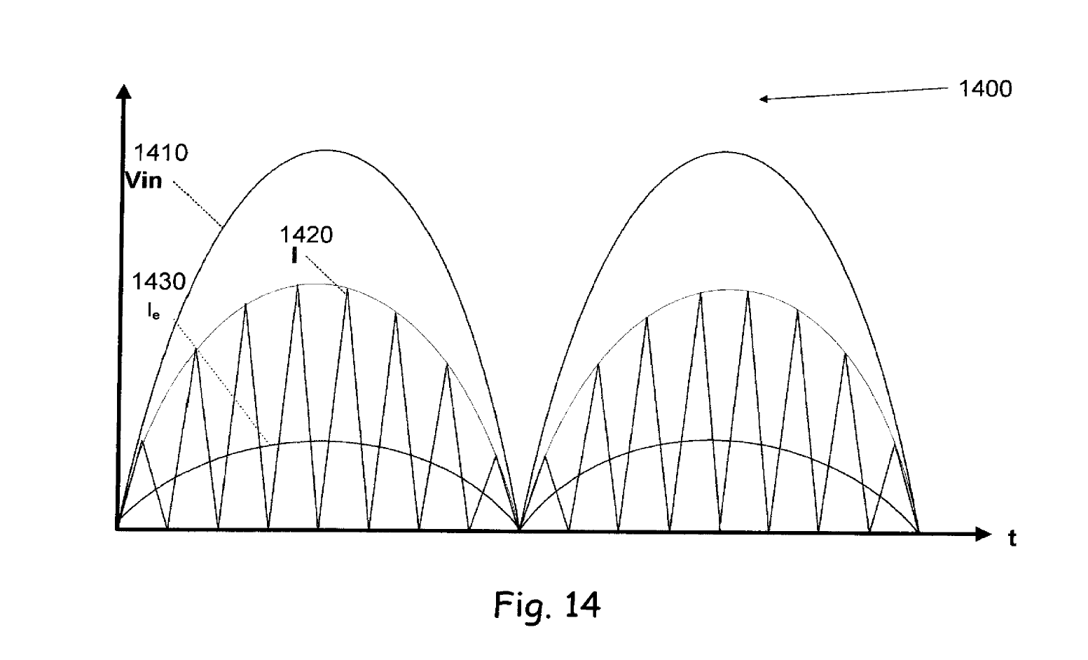

FIG. 14 shows graphs of waveforms of the input voltage and input current, resulting from the operation of the structure in FIG. 13, constructed according to the principles of the present invention. FIG. 14 illustrates the input current and voltage waveforms of the buffer stage 1300. It is shown that the waveform of the input current 1420 is built up by switching it with a high frequency at a constant duty cycle. As a result of such switching, the envelope of the input current Iₑ 1430 is proportional to the input voltage Vᵢₙ 1410.

The duty cycle of the charger may be constant with the current being proportional to the input voltage, or alternatively, the duty cycle may be varied in such a way that that the input current is still proportional to the input voltage changes. The difference between the input and output power causes a change of the voltage on the buffer capacitor and is compensated by the control system by changing the average duty cycle.

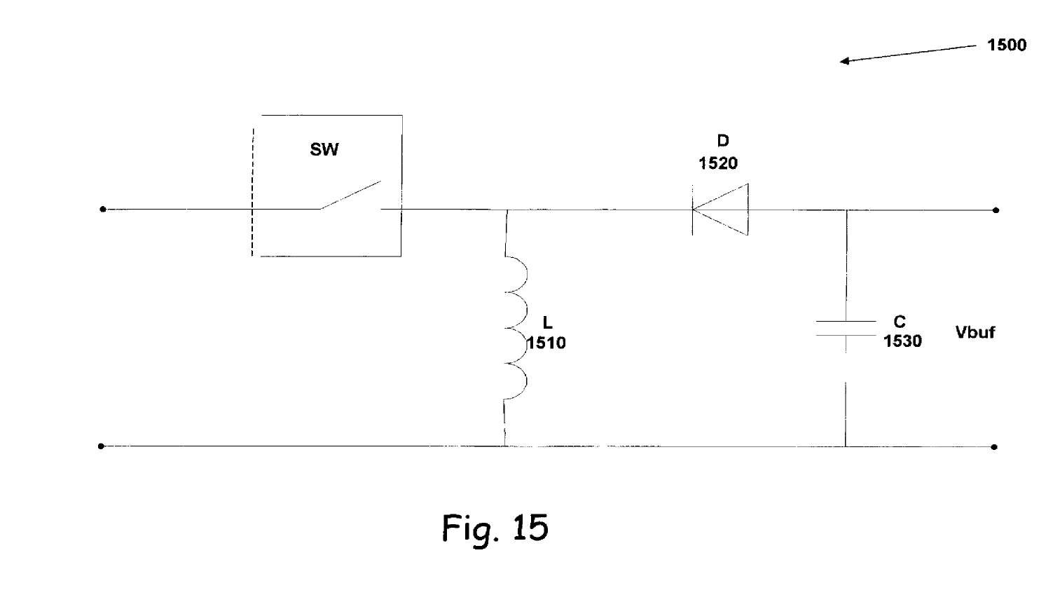

FIG. 15 is a schematic illustration of one of several possible buffer stage implementations, constructed in accordance with the principles of the present invention. The boost topology with a local feedback loop used in the above explanation has the following essential drawback. Since the voltage on the buffer capacitor must always exceed the peak rectified voltage, when the load voltage will start decreasing, the buffer voltage will not drop below the peak rectified voltage, which will impair the proper operation of the buffer stage load. The correct approach to such cases that does not suffer from the above drawback is to employ a general feedback loop that is able to decrease the buffer stage input (rectified) voltage. For example, one can employ the topology in FIG. 15.

FIG. 15 shows an exemplary embodiment of the buffer stage of the current invention. Here the buffer stage is implemented as a buck-boost DC-DC converter 1500, using an inductor L 1510, a diode D 1520 and a capacitor C 1530, configured as shown. This implementation has the following significant advantages in comparison with the boost topology:
1. there is no lower bound on the rectifier output voltage in order to consume the current during the full period of the AC power line:
2. there no in-rush current as in buck-boost topology;
3. a high power factor is obtained over a wide range of loads without a global feed-back loop; and
4. local feedback loops can be used for a wide range of loads and input voltages.

If the implementation of the present invention is a standalone device, then it should comply with appropriate requirements, including safety protections, EMI standards and so on.

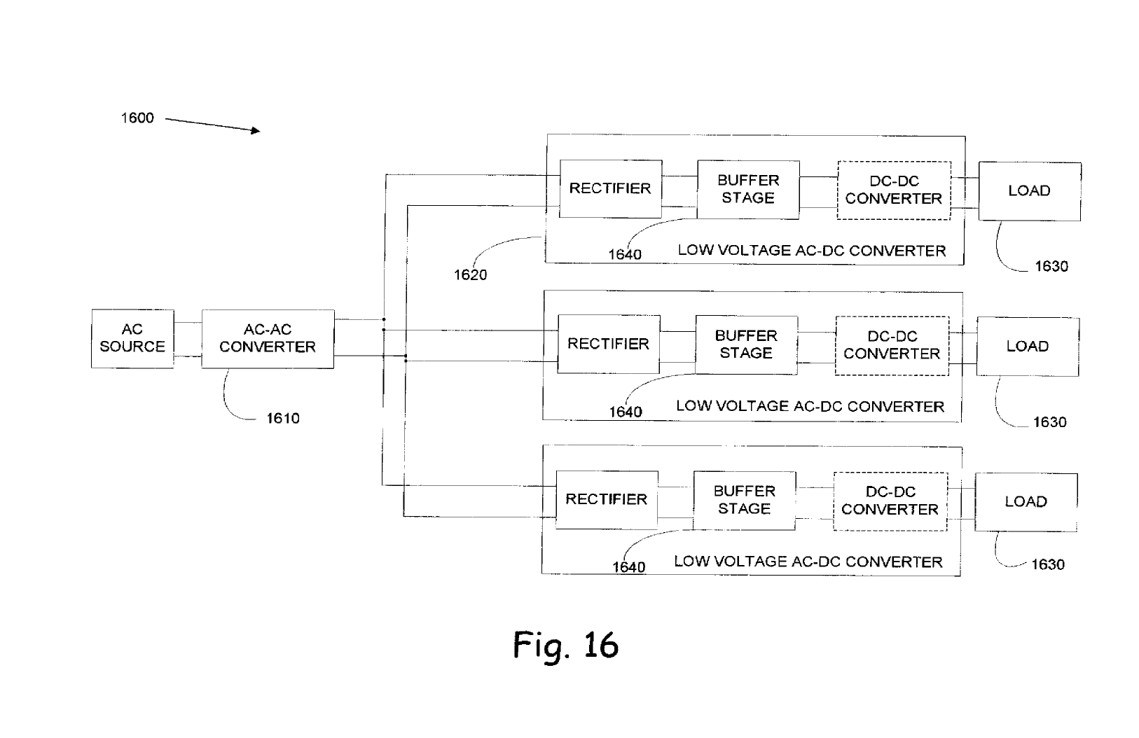

FIG. 16 shows one of the possible implementations of a low voltage high power factor power conversion structure 1600. It comprises a host AC-AC converter 1610 and low voltage AC-DC converters 1620 connected in parallel to the output of AC-AC converter 1610. The loads 1630 are each connected to the output of each of the low voltage AC-DC converters 1620. As has been described above, the buffer stage 1640, which is included in each low voltage AC-DC converter 1620, emulates a proportional load for the preceding stage (in this case AC-AC converter 1610). Therefore there are no special requirements for AC-AC converter 1610 to achieve a high power factor of the whole structure. As a result, the host AC-AC converter 1610 may be a simple magnetic transformer or any electronic capacitor-less AC-AC converter. From this illustration it is clear that the proposed concept enables one to build low voltage high power factor power network circuits.

The present concept can be used to design a dimmable voltage source. If a cut-phase dimmer is placed at the input of a power conversion structure, it is necessary to consider the whole system interaction. As described in US Pat. Applic. No. 20070285028A1, the dimmer influences the power converter and the power converter influences the dimmer. Therefore, it is essential to analyze stability of the whole dimmer-power converter system.

When working with a phase-cut dimmer, it is possible to provide output load regulation by means of the output or buffer stage as a function of the dimmer energy. In some applications it is desirable to eliminate the dependence on the input voltage fluctuations. By using sensors at the input and output of the structure, one can exactly calculate the output power as a function of the dimmer angle (dimmer state). The dimmer angle changes from 0 to 180 degrees during the entire period of the AC power line, and is equivalent to the ignition point for leading edge dimmers or to the cut-off point for trailing edge dimmers. In these calculations one can also to take into account the fluctuation of the input voltage and even the jitter of the dimmer's angle in order to ensure the maximum accuracy and stability of the output power.

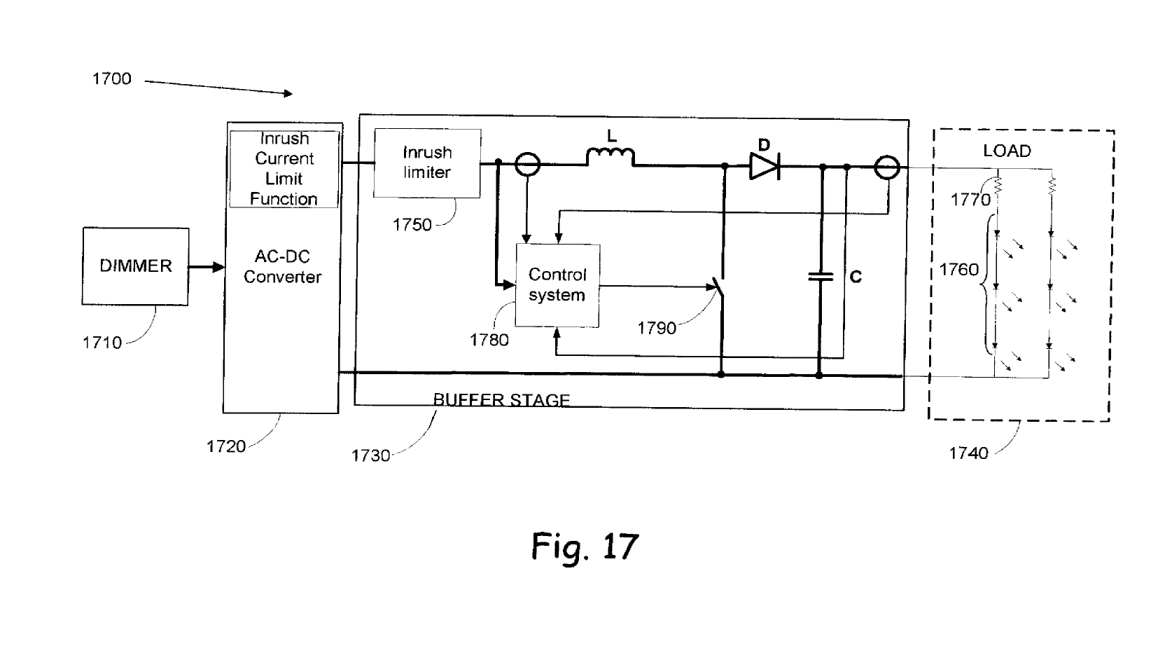

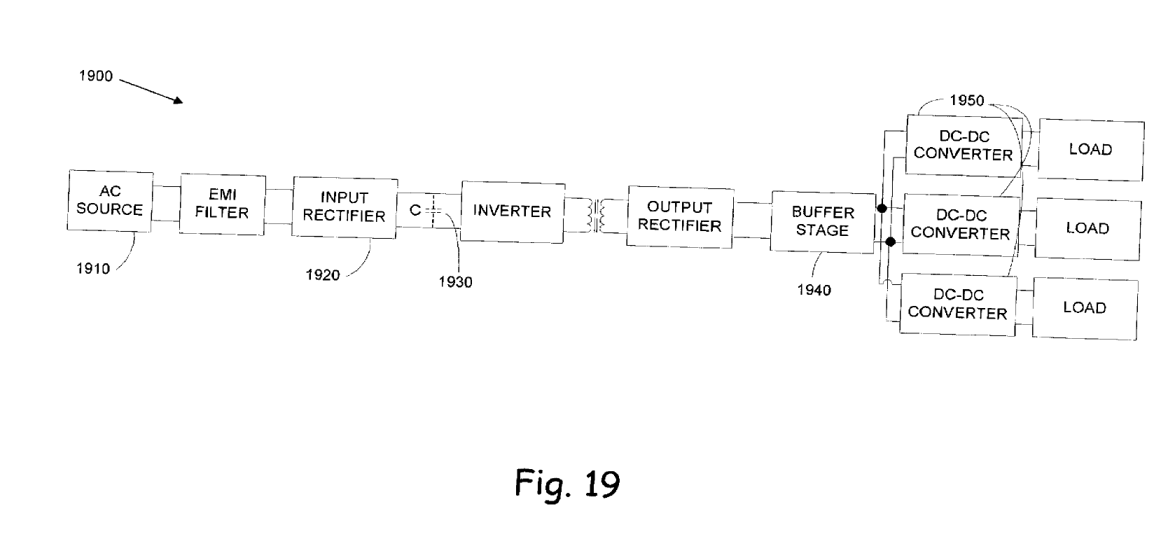

It is clear that one can connect a number of output load control devices after the buffer stage, as described below with reference to FIG. 17 and FIG. 19, wherein each chain consists of:
a DC-DC current source with its serial LED load in the case of an active chain per FIG. 19; and
an LED chain with a serial resistor in the case of a passive chain per FIG. 17.

The drawback of a resistor-based implementation is that different LED load currents are obtained with different numbers of LED's in the chain for the same dimmer angle, which is a result of the same voltage of the buffer capacitor being applied to a different number of LED's.

In order to vary the load current as a function of dimmer angle in FIG. 17 independently of the number of LED's, one can track the average input voltage or the dimmer angle. This means that the converter shall have two feedback loops—the voltage loop and the power loop. When the converter works without a dimmer before it, the converter behaves as a standard constant voltage converter. When the dimmer is placed into the chain, one tracks the output power and measures the input average voltage or the dimmer angle and controls the output power as a function of the average input voltage or of the dimmer angle. In this case, the following conditions necessary for proper dimmer operation have been fulfilled:
1. the dimmer is properly loaded at the full range of its angles; and
2. the current of the load changes with the dimmer angle in the whole range of the dimmer's angle regulation.

FIG. 17 is an exemplary schematic application diagram for a Dimmable Voltage Source Converter 1700, constructed in accordance with the principles of the present invention. This is one of the possible embodiments of the present invention as a dimmable voltage source.

The dimmer 1710 receives input by being connected to a power source (not shown) and its output is connected to the input of an AC-DC Converter 1720, which can be a simple AC-DC capacitor-less converter. The in-rush current limit function for the capacitor charging network can be implemented as a standalone in-rush limiter 1750 or as part of AC-DC converter 1720. The output of AC-DC converter 1720 is coupled to the input of a buffer stage 1730 with the rectified AC power line voltage having a corresponding magnitude.

For simplicity of explanation the boost topology is chosen for the example of FIG. 17. The output of the buffer stage is connected to the load 1740, exemplified by the strings of Light Emitting Diodes (LED's) 1760, each with a serial resistive ballast 1770. Ballast resistors 1770 in the string are chosen so as to minimize the power losses on the resistors, i.e., the drop voltage on these ballast resistors should be very low. Thus one has to provide dimming of the output power using insignificant reduction of the output voltage.

A control system 1780 controls the switch 1790. When the system works without a dimmer, it operates as a standard constant voltage converter. When the system works with a dimmer, control system 1720 measures the input voltage or the input angle and output power, and controls the output voltage in such a way that the output power changes proportionally with the input voltage or with the dimmer angle.

In the same way as described above in connection with FIG. 17, by using sensors at the input and output of the structure, one can exactly calculate the output power as a function of the dimmer angle. In these calculations one can also take into account the fluctuations of the input voltage and even the jitter of the dimmer's angle in order to ensure the maximum accuracy and stability of the output power.

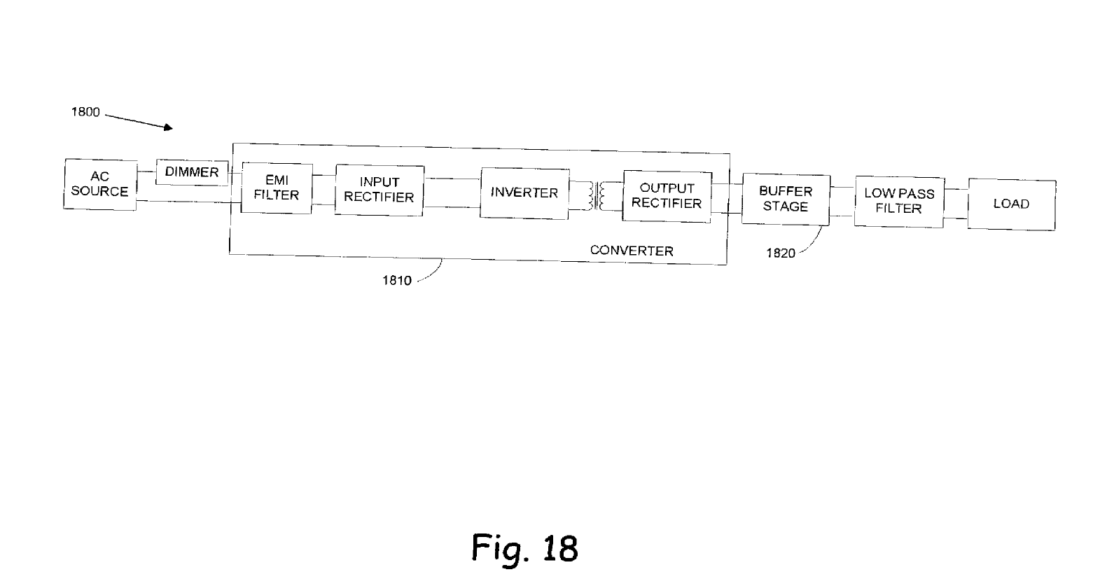

FIG. 18 is a functional structure diagram for a high efficiency, high power factor dimmable electronic transformer power system, constructed in accordance with the principles of the present invention. The structure provides a high power factor and a high efficiency non-stabilized power source, which includes a converter 1810 and buffer stages 1820 only and can serve as a very attractive basis for AC-DC dimmable designs architecture.

Since the buffer stage proportionally loads the AC power source and accumulates energy in the buffer capacitor, the buffer stage provides a high power factor and enables separation of the load from the AC power source for achieving advantages described above. Due to the separation effect, the load properties do not influence the AC power source.

FIG. 19 is a functional structure diagram for system which provides improved conducted emission, constructed in accordance with the principles of the present invention. FIG. 19 illustrates another possible implementation which allows one to build low-power and high-power dimmable circuits, and which has improved EMI characteristics (like immunity, conducted, and radiated emission). This architecture 1900 enables one to reduce EMI in the case where the subsequent DC-DC converter 1950 has a hard switching of high currents leading to large conducted emission. In this case, the buffer stage 1940 separates the source of the conducted emission disturbance from the AC power line 1910. Note that placing the buffer stage between input AC source 1910 and output high power converters 1950, together with a very low capacitance 1930 after the input rectifier 1920 stage, provides a significant advantage for reducing low frequency conducted emission.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for construction of voltage-mode or current-mode power sources receiving a rectified AC input, said power sources based on inclusion of a buffer stage feeding a converter-based output driver feeding a load, said buffer stage comprising:
a buffer capacitance; and
a buffer charger having a control means,
such that the consumed input current from said rectified AC input is proportional to the AC input voltage to said power source,
wherein said buffer stage functions as a charge buffer, enabling maintainance of the consumed input current over the entire period of said AC input voltage, and acting to separate said output driver and load from the consumed input current.

2. The method of construction of claim 1, wherein said buffer stage is employed at the load side.

3. The method of claim 1, further comprising a cut-phase dimmer connected at the AC input, wherein said dimmer is properly loaded over all phase angles.

4. The method of claim 1 as provided for distributed power conversion, further comprising an input AC-AC converter directly connected to an input grid or connected via a cut phase dimmer, and further comprising at least one low voltage AC-DC converter connected to the output of said input AC-AC converter, wherein the output of said input AC-AC converter is connected to at feast one low voltage AC-DC converter which is connected to its load.

5. The method of claim 1, wherein said buffer stage has feedback from the output in order to achieve the required operation.

6. The method of claim 5 further comprising a transformer for isolating the input and output sides of said converter.

7. The method of claim 5, wherein said host AC-AC converter does not destroy the power factor.

8. The method of claim 5, wherein said host AC-AC converter is a magnetic transformer.

9. The method of claim 5, wherein said host AC-AC converter is an electronic AC-AC converter.

10. A device for power conversion with a high power factor comprising:
an input rectifier;
a high frequency DC/DC converter feeding a buffer stage;
a buffer stage comprising at least a buffer capacitance and a buffer charger having a control means configured to make the consumed current proportional to the rectified AC power line voltage; and
an output current driver feeding the load,
wherein said buffer stage has feedback from the output in order to achieve the required operation.

11. A current source providing a high power factor and able to regulate the output current as a function of the dimmer state, when a dimmer connected to the input, said current source comprising:
an input rectifier;
a high frequency DC/DC converter feeding a buffer stage;
a buffer stage comprising at least a buffer capacitance and a buffer charger having a control means configured to make the consumed current proportional to the rectified AC power line voltage; and
an output current driver feeding the load,
wherein said buffer stage has feedback from the output in order to achieve the required operation.

12. A voltage source providing a high power factor, and able to regulate the output current as a function of the dimmer state when connected to the input, said voltage source comprising:
an input rectifier;
a high frequency DC/DC converter feeding a buffer stage;
a buffer stage comprising at least a buffer capacitance and a buffer charger having a control means configured to make the consumed current proportional to the rectified AC power line voltage; and
an output voltage driver feeding the load,
wherein said buffer stage has feedback from the output in order to achieve the required operation.
